(19) United States
(12) Patent Application Publication
(10) Pub. No.: US 2014/0259026 A1
(43) Pub. Date: Sep. 11, 2014

(54) METHOD AND DEVICE FOR EXECUTING MULTI-TASK BY MICROCONTROLLER OF ELECTRONIC CIGARETTE

(71) Applicant: Zhiyong Xiang, Shenzhen (CN)

(72) Inventor: Zhiyong Xiang, Shenzhen (CN)

(21) Appl. No.: 13/895,685

(22) Filed: May 16, 2013

(30) Foreign Application Priority Data
Mar. 5, 2013 (CN) 201310069923.8

(51) Int. Cl. G06F 9/48

(52) U.S. Cl. CPC G06F 9/4881
USPC 718/107

(57) ABSTRACT

The present invention discloses method and device for executing multi-tasks by a microcontroller of an electronic cigarette. The method includes these steps: determining tasks to be executed by the microcontroller and an allowed time interval between two executions of each of the tasks; dividing executing time of each task into a plurality of time slices in orderly, and making the sum of the time slices of each task to be less than or equal to the minimum value of all of the time interval; setting a status bit for each task, and directing the status bit to the time slice of the task; executing each task according to a time slice corresponding to the current status bit of the task, and switching to a next task while the time slice corresponding to the current status bit ends.

### CROSS-REFERENCE TO RELATED APPLICATIONS

This non-provisional application claims priority under 35 U.S.C. §119(a) on Patent Application No. 201310069923.8 filed in P.R. China on Mar. 5, 2013, the entire contents of which are hereby incorporated by reference.

### FIELD OF THE INVENTION

The present invention relates to the field of electronic cigarettes, and more particularly relates to a method and device for executing multi-tasks by microcontrollers of electronic cigarettes.

### BACKGROUND OF THE INVENTION

An electronic cigarette can heat and atomize the tobacco juice, and provides substitute for a traditional cigarette to smokers. Thus, the electronic cigarettes have been more and more popular with smoking consumers.

At present, in an electronic cigarette, the microcontroller of the cigarette is configured to dispose various tasks, such as detecting a smoking sensor, driving an atomizer heating, detecting an over-current of loads, detecting a short circuit of loads and charging detections. The microcontroller disposes these tasks as task modules. In such case, when one task is finished, a next task is executed. Microcontroller will turn back to execute the first task when the last task is finished. In this way, the tasks are executed in circulatory.

However, some task modules, such as load over-current detections and load short circuit detections, may need very short time intervals generated between executions of two adjacent tasks. Because time lengths of executing different tasks are different, when a task is first finished and the microcontroller circulates to execute the task again, a time interval between the two executions of the task may exceed the required time interval between the two executions of the task. Therefore, when a method of using the microcontroller to execute the tasks in circulatory in the prior art is adopted, failures of some tasks may be caused. Thus, functions corresponding to these tasks may sometimes exist and sometimes disappear, and the system may be instable. Furthermore, other bad consequences may also be generated, for example, circuits may be burned out, a whole electronic cigarette may fail, and fire may even be generated.

### SUMMARY OF THE INVENTION

Aiming at the drawbacks in the prior art that the way that the microcontroller execute the tasks in circulatory in the prior art will cause the system instability and other bad consequences. A method and device for executing multi-tasks by a microcontroller of an electronic cigarette is provided. Wherein such method and device for executing multi-tasks can improve the efficiency for executing tasks by the microcontroller of the electronic cigarette and the system can be stable.

According to an aspect, a proposed a method for executing multi-tasks by a microcontroller of an electronic cigarette, the microcontroller configured to dispose multi-tasks, wherein the microcontroller includes a timer, and wherein the method includes these steps:

step 1: determining tasks to be executed by the microcontroller and an allowed time interval between two executions of each of the tasks;

step 2: dividing executing time of each task into a plurality of time slices in orderly, and making the sum of any one of the time slices of each task to be less than or equal to the minimum value of all of the time intervals;

step 3: setting a status bit for each task, and directing the status bit to the time slice of the task;

step 4: executing each task according to a time slice corresponding to the current status bit of the task, and switching to a next task while the time slice corresponding to the current status bit ends.

The step of setting the status unit for each task and directing the status unit to the time slice of the task further includes:

when the current task is switched to a next task, directing the status unit of the current task to a next time slice; or

when the status unit of the current task has already directed to the last time slice, directing the status unit of the current task to a first time slice.

The step of switching to the next task of the task while the time slice corresponding to the current status unit ends further includes:

setting a timing time for the timer, wherein the timing time is equal to the time slice directed by the current status unit; and

when the timing time comes, switching tasks.

The method for executing multi-tasks further includes:

determining the time slices of each task according to the requirement of the task and determining the number of the time slices of each task according to the executing time and each time slice of the task.

A device for executing multi-tasks by microcontroller of electronic cigarette, the microcontroller configured to dispose multi-tasks, wherein the microcontroller includes a timer, and wherein the device includes:

a task determining module configured to determining tasks to be executed by the microcontroller and an allowed time interval between two executions of each of the tasks;

a time dividing module configured to divide executing time of each task into a plurality of time slices in orderly, and make the sum of any one of the time slices of each task to be less than or equal to the minimum value of all of the time intervals;

a status unit determining module configured to set status bit for each task and directing the status bit to the time slice of the task;

a task executing and switching module configured to execute each task according to a time slice corresponding to the current status bit of the task, and switch to a next task while the time slice corresponding to the current status bit ends.

The status unit determining module is further configured to direct a status unit of a current task to the next time slice of the task when the current task is switched to a next task; or direct the status unit of the current task to a first time slice when the status unit of the current task is directed to the last time slice.

The task executing and switching module is further configured to setting a timing time of the timer, wherein the timing time is equal to the time slice directed to the current status unit and switched the task when the timing time comes.

When implanting the invention, the following advantages can be achieved: the efficiency for executing tasks by the microcontroller of the electronic cigarette can be improved, which enables the system of the electronic cigarette to be more stable; and the microcontroller requires lower property, costs less, and is more easy to fabricate.

### BRIEF DESCRIPTION OF THE DRAWINGS

The present invention can be further illustrated by reading the example with references made to the accompanying drawings, in which:

FIG. 1 is a flow chart of a method for executing multi-task by microcontroller of electronic cigarette according to one embodiment of the invention; and

FIG. 2 is a schematic diagram of switching tasks while executing tasks according to the method for executing multi-task by the microcontroller of the electronic cigarette of the invention as shown in FIG. 1; and

FIG. 3 is a schematic diagram of a device for executing multi-tasks by a microcontroller of an electronic cigarette according to one embodiment of the invention.

### DETAILED DESCRIPTION OF THE PREFERRED EMBODIMENT

For recognizing the technique character, the object and the effect more clearly, the special implement of the invention is illustrated in detail with references to the accompanying drawings.

In the embodiment of the invention, a microcontroller of an electronic cigarette is configured to dispose multi-tasks. Wherein such tasks include detecting a smoking sensor, driving an atomizer heating, detecting an over-current of loads, detecting a short circuit of loads and charging detections, and so on. The microcontroller must switch tasks in a high efficiency and stable way, because of so many tasks to be disposed. A method and device for executing multi-tasks by the microcontroller of the electronic cigarette according to the embodiment of the invention can make the time for executing each task responsibly, so that the microcontroller can control the whole system of the electronic cigarette stably and in high efficiency.

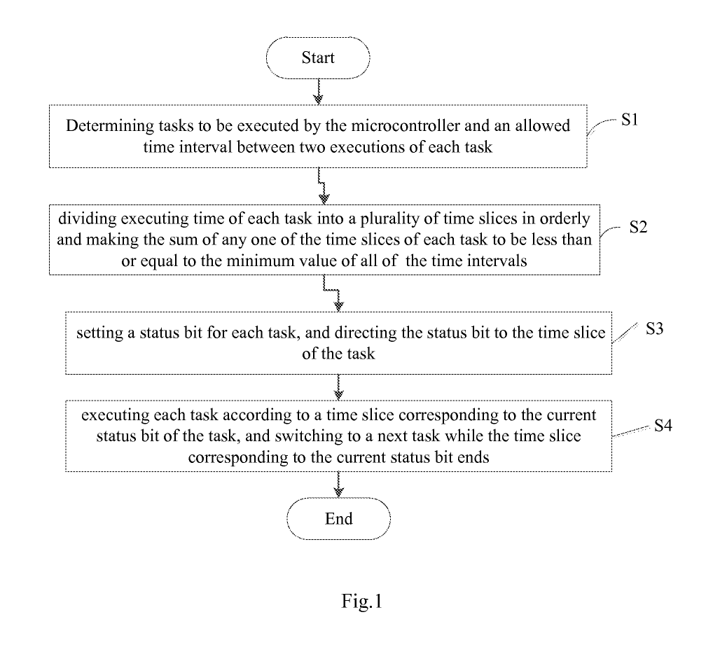

FIG. 1 is a method for executing multi-tasks by the microcontroller of the electronic cigarette. Wherein the microcontroller is configured to dispose multi-tasks. The method includes these steps:

S1: determining tasks to be executed by the microcontroller and an allowed time interval between two executions of each of the tasks.

The time interval between two executions of each of the tasks means a time interval that is measured from one time when each task is finished to another time when the task is executed again by the microcontroller. Different tasks require different time intervals, for example, an allowed time interval for detecting short circuits of loads is about 1 ms to make the short circuit of the load can be detected at any time; however, an allowed time interval for detecting the smoking sensor is about 100 ms. The time interval may be determined according to timeliness of the tasks'. If a task requires higher timeliness, the time interval required by the task is smaller. The time intervals may also be determined according to other requirements of the tasks.

S2: dividing executing time of each task into a plurality of time slices in orderly, and make the sum of any one of the time slices of each task to be less than or equal to the minimum value of all of the time intervals.

The executing time of each task is divided into a plurality of time slices in orderly, and makes the sum of any one of the time slices of each task to be less than or equal to the minimum value of all of the time intervals. In such case, during the tasks being executed circularly, it can make the time between two executions of a task with the smallest time interval meet the requirement of the time interval of the task. For example, assuming that the number of the tasks to be executed by the microcontroller is 4, that is, the tasks include task 1, task 2, task 3 and task 4. Furthermore, a minimum of the time intervals of the tasks is the time interval of task 1: 10 ms. In such case, the divided time slice of each task should meet the requirement that the sum of time slice of task 1, time slice of task 2, time slice of task 3 and time slice of task 4 is less than or equal to 10 mms. In order to meet such condition, the time slice of task 1 may be 2 ms, the time slice of task 2 may be 5 ms, the time slice of task 3 may be 1 ms and the time slice of task 4 may be 2 ms.

Moreover, the time slice of each task should be divided according to specific case of each task to ensure the responsibility of the executed task in the time slice. Therefor, time slice of each task and different time slices can be different. The time slice of each task can be determined according to the task's requirement and the number of the time slice of each task may be determined according to the executing time and the time slice of each task. For example, in a button detection task of the electronic cigarette, the button detection needs to wait for avoiding flutter delay. If the time for touching the button is 5 ms and the time for avoiding flutter delay is 10 ms, the time slice of the button detection task should be 5 ms as the preferred such that detecting for the operation of touching button can be finished in the time slice.

S3: setting a status bit for each task, and directing the status bit to the time slice of the task.

During the process of task switched and executed circularly, in order to obtain accurate executing status of each task, the task should be set with a status unit to record executing status messages of the task. The status unit is directed to the time slice of the task. The case of executing task can be obtained according to the time slice directed by the status unit after setting status unit for each task. For example, if the status unit of task is directed to the second time slice, it should be understood that the executing status of the task has been completely executed in the second time slice.

when the current task is switched to a next task, the status unit of the current task is directed to a next time slice; or when the status unit of the current task has already directed to the last time slice, the status unit of the current task is directed to a first time slice. When one time slice of the task is finished, the status unit is directed to the next time slice, and when all of the time slices of the task is finished, the status unit go back to the initial status unit and the status unit is directed to the first time slice. For example, the number of the time slices of task 1 is 5, and the initial unit is directed to the first time slice. In such case, task 1 is executed in first time according to the time slice corresponding to the status unit, then executing the first time slice of task 1 until the first time slice is over, the status unit is directed to the second time slice. When task 1 is executed in second time according to the time slice corresponding to the status unit, executing the second time slice of task 1 until the second time slice is over, the status unit is directed to a third time slice. By parity of reasoning, after the status unit directed to the fifth time slice then go back to the first time slice. The status unit of one task directed to the last time slice then went back to the first time slice means that the task has been executed one time.

S4: executing each task according to a time slice corresponding to a current status bit of the task, and switching to a next task while the time slice corresponding to the current status bit ends.

In order to switching the tasks, the timing time of the timer should be set, and make the timing time is equal to one time slice of each task. In such case, when the timing time comes, switch tasks.

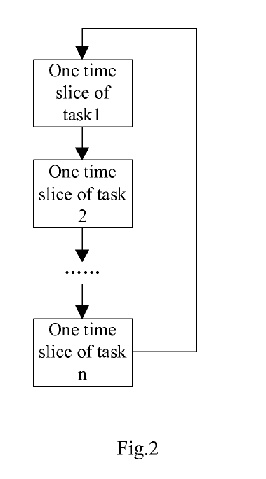

FIG. 2 is a schematic diagram of a method for switching tasks while executing tasks according to the method for executing multi-tasks by microcontroller of electronic cigarette of the invention as shown in FIG. 1. As shown in FIG. 2, the tasks to be executed by the microcontroller of the electronic cigarette includes task 1, task 2, . . . task n. The executing time of the task 1, task 2, . . . task n are divided into time slices containing different amount. According to the method for executing multi-tasks by the microcontroller of the electronic cigarette in the invention, the microcontroller does not execute these tasks according to the sequence of the task 1, task 2 . . . , task n, but according to the type of the time slice. As executing task 1, it is actual that not all of time slices of task 1 but one time slice of task 1 is executed. When the time slice of task 1 has been ended, then the microcontroller switch to one time slice of task 2. By parity of reasoning, when one time slice of all of the tasks is finished, execute one time slice of task 1 again. According to the method or executing multi-tasks by the microcontroller of the electronic cigarette in the invention, switching tasks, in practical, is to switch to different time slice of different tasks. However, each time slice of different tasks may be determined according to requirements of different tasks. The number of the time slices of different tasks may be determined according to the executing time and each time slice of the task. Therefor, the practical executing time of each task decreases to one time slice from the total time for executing the task in the prior art. However, the time spends by the microcontroller switches to the same task in the second times, which decreases to the sum of one slice of all of tasks from the total executing time of all of the tasks in the prior art. According to the case of dividing executing time of each task into a plurality of time slices in orderly, and making a sum of any one of the time slices of each task to be less than or equal to the minimum value of all of the time intervals. Therefor, the timeliness of tasks can be determined, even the required minimum time interval task such as detecting the short circuit of the load, and won't cause these tasks failure because of the time between two executions of the task exceeded the required time.

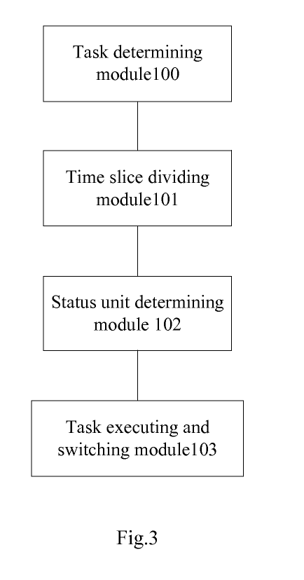

FIG. 3 is a schematic diagram of a device for executing multi-tasks by a microcontroller of an electronic cigarette according to one embodiment of the invention. The device includes:

a task determining module 100 configured to determine tasks to be executed by the microcontroller and an allowed time interval between two executions of each task;

a time dividing module 101 configured to divide executing time of each task into a plurality of time slices in orderly, and making the sum of any one of the time slices of each task to be less than or equal to the minimum value of all of the time intervals;

a status unit determining module 102 configured to set a status bit for each task, and directing the status bit to the time slice of the task.

the status unit determining module 102 is further configured to direct a status unit of a current task to the next time slice of the task when the current task is switched to a next task, or direct the status unit of the current task to a first time slice when the status unit of the current task is directed to the last time slice.

a task executing and switching module 103 configured to execute each task according to a time slice corresponding to a current status bit of the task, and switching to a next task while the time slice corresponding to the current status bit ends.

The task executing and switching module 103 is further configured to set a timing time of the timer, wherein the timing time is equal to the time slice directed to the current status unit, and switch the task when the timing time comes.

It should be understood that the device 100,101,102,103 can be substituted by the microcontroller of the electronic cigarette to dispose the data.

It should be understood that the specific process of the device or module is corresponding with the method as described, and there is no need to be described in detail.

When the method and device for executing multi-tasks by the microcontroller of the electronic cigarette are implanted by the way of dividing the executing time of each task into a plurality of time slices in orderly and making the sum of any one of the time slices of each task to be less than or equal to the minimum value of all of the time intervals, the efficiency for executing tasks by the microcontroller of the electronic cigarette can be improved, which enables the system of the electronic cigarette to be more stable, and the microcontroller requires lower property, costs less, and is more easy to fabricate.

While the present invention has been described by reference to preferred embodiments, it will be understood by those skilled in the art that various changes may be made and equivalents may be substituted without departing from the scope of the present invention. However, all the changes will be included within the scope of the appended claims.

What is claimed is:

1. A method for executing multi-tasks by a microcontroller of an electronic cigarette, the microcontroller configured to dispose multi-tasks, wherein the microcontroller includes a timer, and wherein the method includes these steps:
step 1: determining tasks to be executed by the microcontroller and an allowed time interval between two executions of each of the tasks;
step 2: dividing executing time of each task into a plurality of time slices in orderly, and making the sum of any one of the time slices of each task to be less than or equal to the minimum value of all of the time intervals;
step 3: setting a status bit for each task, and directing the status bit to the time slice of the task;
step 4: executing each task according to a time slice corresponding to the current status bit of the task, and switching to a next task while the time slice corresponding to the current status bit ends.

2. The method for executing multi-tasks of claim 1, wherein the step of setting the status unit for each task and directing the status unit to the time slice of the task further includes:
when the current task is switched to a next task, directing the status unit of the current task to a next time slice; or
when the status unit of the current task has already directed to the last time slice, directing the status unit of the current task to a first time slice.

3. The method for executing multi-tasks of claim 1, wherein the step of switching to the next task of the task while the time slice corresponding to the current status unit ends further includes:
setting a timing time for the timer, wherein the timing time is equal to the time slice directed by the current status unit; and
when the timing time comes, switching tasks.

4. The method for executing multi-tasks of claim 1, wherein further includes:
determining the time slices of each task according to the requirement of the task and determining the number of the time slices of each task according to the executing time and each time slice of the task.

5. A device for executing multi-tasks by microcontroller of electronic cigarette, the microcontroller configured to dispose multi-tasks, wherein the microcontroller includes a timer, and wherein the device includes:
a task determining module configured to determining tasks to be executed by the microcontroller and an allowed time interval between two executions of each of the tasks;
a time dividing module configured to divide executing time of each task into a plurality of time slices in orderly, and making the sum of any one of the time slices of each task to be less than or equal to the minimum value of all of the time intervals;
a status unit determining module configured to set status bit for each task and directing the status bit to the time slice of the task;
a task executing and switching module configured to execute each task according to a time slice corresponding to the current status bit of the task, and switch to a next task while the time slice corresponding to the current status bit ends.

6. The device for executing multi-tasks of claim 5, wherein the status unit determining module is further configured to direct a status unit of a current task to the next time slice of the task when the current task is switched to a next task, or direct the status unit of the current task to a first time slice when the status unit of the current task is directed to the last time slice.

7. The device for executing multi-tasks of claim 5, wherein the task executing and switching module is further configured to setting a timing time of the timer, wherein the timing time is equal to the time slice directed to the current status unit and switched the task when the timing time comes.
